(19) United States
(12) Patent Application Publication
(10) Pub. No.: US 2014/0173549 A1
(43) Pub. Date: Jun. 19, 2014

(54) COMPUTING DEVICE AND METHOD OF CHECKING WIRING DIAGRAMS OF PCB

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventors: YA-LING HUANG, Shenzhen (CN); CHIA-NAN PAI, Tu-Cheng (TW); SHOU-KUO HSU, Tu-Cheng (TW)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 14/051,500

(22) Filed: Oct. 11, 2013

(30) Foreign Application Priority Data
Dec. 13, 2012 (CN) 201210537331X

(51) Int. Cl. G06F 17/50

(52) U.S. Cl. CPC G06F 17/50
USPC 716/136

(57) ABSTRACT

In a method for checking a wiring diagram in a printed circuit board (PCB) design, a pair of differential signal lines in a PCB file is located according to a designation of a user. Components connected by the differential signal lines and vias which the differential signal lines pass through are obtained from the PCB file. A determination of whether obtained components and the obtained vias meet predetermined requirements is made by checking whether copper foils between each pair of the obtained vias or between pins of the obtained components in ground layers and power layers of the PCB file are hollowed.

### BACKGROUND

1. Technical Field

Embodiments of the present disclosure relate to wiring design, and more particularly to a computing device and a method of checking wiring diagrams of a printed circuit board (PCB) design.

2. Description of Related Art

Electronic devices, such as mobile phones and computers, may include one or more printed circuit boards (PCBs). The PCB mechanically supports and electrically connects electronic components, such as resistors, capacitors, using signal lines. In order to assure the stability and reliability of a PCB, it is necessary to perform a series of checks of the wiring of the PCB. In traditional check methods, the check may be performed manually, which may be complicated, inefficient, and costly. Therefore, a more efficient system and method for checking wiring of a PCB layout file is desired.

### BRIEF DESCRIPTION OF THE DRAWINGS

FIG. 1 is a block diagram of one embodiment of a computing device including a wiring check system.

FIG. 2 is a block diagram of one embodiment of function modules of the wiring check system in FIG. 1.

FIGS. 3A to 3B illustrate a flowchart of one embodiment of a method for checking a wiring diagram of a PCB.

### DETAILED DESCRIPTION

In general, the word “module,” as used hereinafter, refers to logic embodied in hardware or firmware, or to a collection of software instructions, written in a programming language, such as, for example, Java, C, or Assembly. One or more software instructions in the modules may be embedded in firmware. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

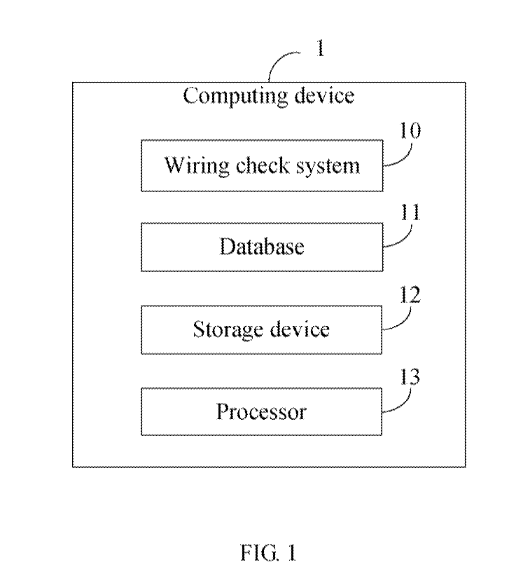

FIG. 1 is a block diagram of one embodiment of a computing device 1 including a wiring check system 10. The computing device 1 may be a computer, a server, for example. The computing device 1 may further include a database 11, a storage device 12, and a processor 13, etc. One skilled in the art would recognize that the computing device 1 may be configured in a number of other ways and may include other or different components.

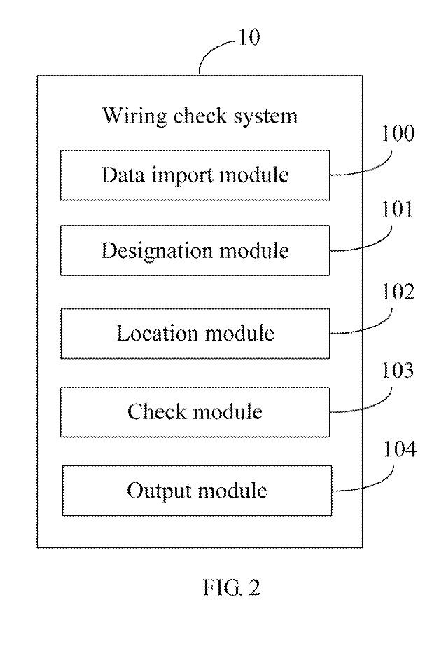

The wiring check system 10 includes a number of function modules (depicted in FIG. 2). The function modules may include computerized codes in the form of one or more programs, which have functions of automatically checking a wiring diagram of a printed circuit board (PCB).

The database 11 stores PCB files. Each of the PCB files includes a wiring diagram and data relating to the wiring diagram. The wiring diagram is a simplified conventional pictorial representation of an electrical circuit, in which multiple electrical components are wired together using signal lines. The data relating to the wiring diagram includes information of the components and the signals lines in the wiring diagram and copper foils information in each layer of the PCB. The information of the component includes, names, Identifications (IDs), pins, and coordinates of the components, etc. The information of the signals lines includes, names, paths, line lengths, line widths, line spaces, and so on.

The storage device 12 may include some type(s) of computer-readable storage medium, such as a hard disk drive, a compact disc, a digital video disc, or a tape drive. The storage device 12 stores the computerized code of the function modules of the wiring check system 10 for execution by the processor 13.

The processor 13 may include a processor, a microprocessor, an application-specific integrated circuit (ASIC), and a field programmable gate array, (FPGA) for example. The processor 13 may execute the computerized code of the function modules of the wiring check system 10 to realize the functions of the wiring check system 10.

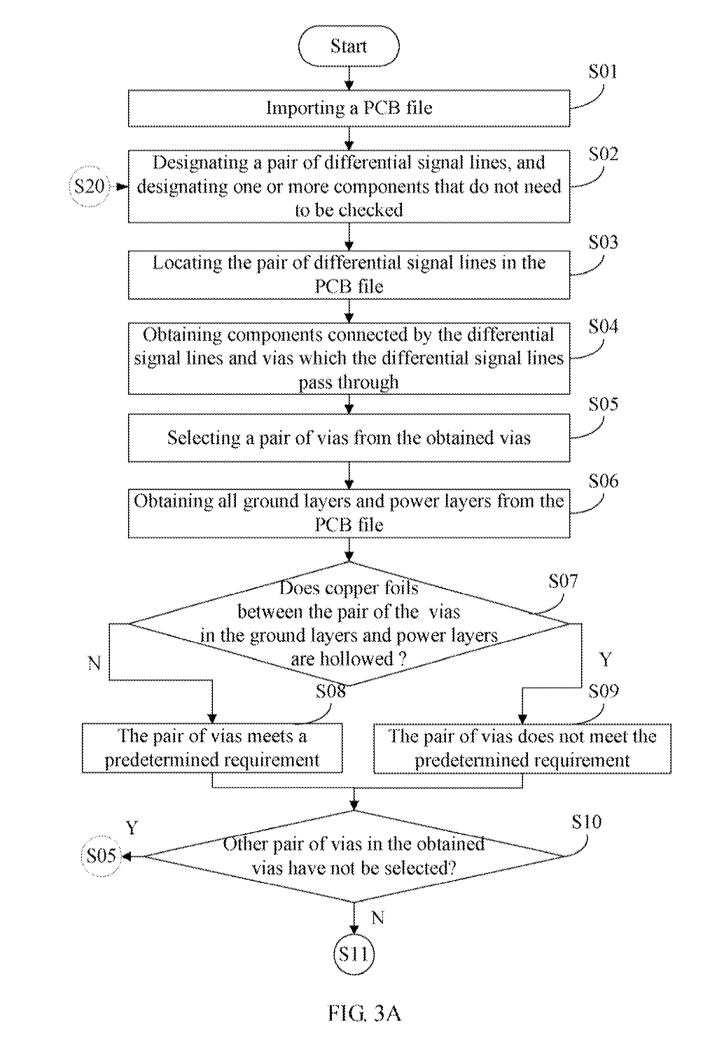

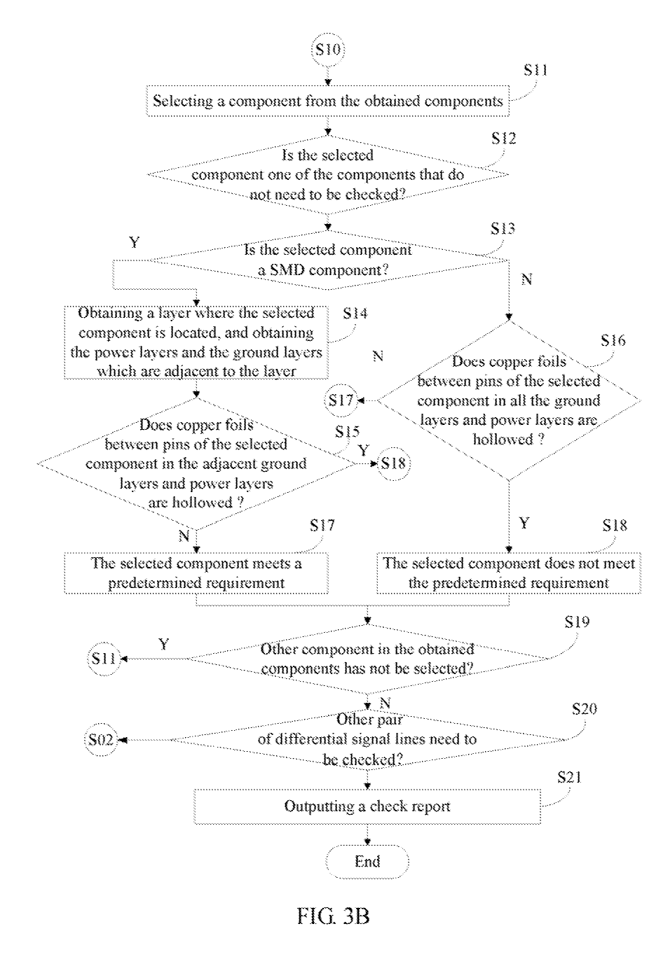

FIG. 2 is a block diagram of one embodiment of the function modules of the wiring check system 10. In one embodiment, the wiring check system 10 may include a data import module 100, a designation module 101, a location module 102, a check module 103, and an output module 104. The function modules 100-104 provide at least the functions needed to execute the steps illustrated in FIGS. 3A to 3B.

FIGS. 3A to 3B illustrate a flowchart of one embodiment of a method for checking a wiring diagram of a PCB. Depending on the embodiment, additional steps may be added, others removed, and the ordering of the steps may be changed.

In step S01, the data import module 100 imports a PCB file from the database 11 of the computing device 1. As mentioned, the PCB file includes a wiring diagram and data relating to the wiring diagram. The data relating to the wiring diagram includes information of the components and the signals lines in the wiring diagram.

In step S02, the designation module 101 designates a pair of differential signal lines, and designates one or more components that do not need to be checked. In one embodiment, the designation module 101 provides a signal line list for a user to select a name of a pair of differential signal lines, and provides a component list for the user to select names of one or more components that do not need to be checked. The designation module 101 designates the pair of differential signal lines and the one or more components that do not need to be checked according to the selections made by the user.

In step S03, the location module 102 locates the designated pair of differential signal lines in the PCB file. In one embodiment, the location module 102 locates the designated pair of differential signal lines in the PCB file according to the information of the signals lines included in the PCB file.

In step S04, the location module 102 obtains components connected by the designated differential signal lines and vias which the designated differential signal lines pass through, from the PCB file.

In step S05, the check module 103 selects a pair of vias from the obtained vias.

In step S06, the check module 103 obtains all ground layers and power layers from the PCB file.

In step S07, the check module 103 checks whether copper foils between the selected pair of the vias in the ground layers and power layers are hollowed. Step S08 is implemented when the copper foils between the selected pair of the vias in the ground layers and power layers are hollowed. Otherwise, Step S09 is implemented when the copper foils between the selected pair of the vias in the ground layers and power layers are not hollowed.

In step S08, the check module 103 makes a decision that the selected pair of vias meets a predetermined requirement.

In step S09, the check module 103 makes a decision that the selected pair of vias does not meet the predetermined requirement.

In step S10, the check module 103 determines whether other pair of vias in the obtained vias have not be selected. Until each pair of vias in the obtained vias has been selected, the procedure returns to step S05. Otherwise, step S11 (see FIG. 3B) is implemented when every pair of vias in the obtained vias has been selected.

In step S11, the check module 103 selects a component from the obtained components.

In step S12, the check module 103 checks whether the selected component is one of the components that do not need to be checked. Until the selected component is not one of the components that do not need to be checked, step S11 is repeated. Otherwise, step S13 is implemented when the selected component is not one of the components that do not need to be checked.

In step S13, the check module 103 checks whether the selected component is a surface mounted device (SMD) component. Step S14 and S15 are implemented when the selected component is a SMD component. Step S16 is implemented when the selected component is not a SMD component.

In step S14, the check module 103 obtains a layer where the selected component is located, and obtains a power layer and a ground layer which are adjacent to the layer where the selected component is located.

In step S15, the check module 103 checks whether copper foils between pins of the selected component in the adjacent ground layer and power layer are hollowed. Step S17 is implemented when the copper foils between pins of the selected component in the adjacent ground layer and power layer are hollowed. Otherwise, step S18 is implemented when the copper foils between pins of the selected component in the adjacent ground layer and power layer are not hollowed.

In step S16, the check module 103 checks whether copper foils between pins of the selected component in all the ground layers and power layers are hollowed. Step S17 is implemented when the copper foils between pins of the selected component in all the ground layers and power layers are hollowed. Otherwise, step S18 is implemented when the copper foils between pins of the selected component in all the ground layers and power layers are not hollowed.

In step S17, the check module 103 makes a decision that the selected component meets a predetermined requirement.

In step S18, the check module 103 makes a decision that the selected component does not meet the predetermined requirement.

In step S19, the check module 103 determines whether other component in the obtained components has not be selected. Until all the components in the obtained components have been selected, the procedure returns to step S11. Otherwise, step S20 is implemented when all the components in the obtained components have been selected.

In step S20, the designation module 101 determines whether other pair of differential signal lines need to be checked. As mentioned above, the designation module 101 provides a signal line list for a user to select a name of a pair of differential signal lines. When the user selects another pair of differential signal lines using the signal line list, the designation module 101 determines that other pair of differential signal lines need to be checked, and the process goes to step S02. Otherwise, when the user does not select any pair of differential signal lines, the designation module 101 determines that no differential signal lines need to be checked, and step S21 is implemented.

In step S21, the output module 104 outputs a check report. The check report displays the pairs of vias and the components that do not meet the predetermined requirements.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computerized method for checking a wiring diagram of a printed circuit board (PCB), the method being executed by at least one processor of a computing device and comprising:
importing a PCB file;
designating a pair of differential signal lines;
locating the designated pair of differential signal lines in the PCB file;
obtaining components connected by the differential signal lines and vias, which the differential signal lines pass through, from the PCB file;
determining whether obtained components and the obtained vias meet predetermined requirements by checking whether copper foils between each pair of the obtained vias or between pins of the obtained components in ground layers and power layers of the PCB file are hollowed; and
outputting a check report which displays the pairs of vias and the components that do not meet the predetermined requirements.

2. The method according to claim 1, further comprising:
designating one or more components that do not need to be checked; and
filtering the designated components from the obtained components when determining whether obtained components meet the predetermined requirement.

3. The method according to claim 2, further comprising:
providing a signal line list for a user to select a name of a pair of differential signal lines, and providing a component list for the user to select names of one or more components that do not need to be checked.

4. The method according to claim 1, wherein the determining step comprises:
selecting a pair of vias from the obtained vias;
obtaining all the ground layers and the power layers from the PCB file;
checking whether copper foils between the selected pair of the vias in all the ground layers and the power layers are hollowed; and
making a decision that the selected pair of vias meets a predetermined requirement when the copper foils between the selected pair of the vias in all the ground layers and power layers are hollowed; or
making a decision that the selected pair of vias do not meet the predetermined requirement when the copper foils between the selected pair of the vias in all the ground layers and the power layers are not hollowed.

5. The method according to claim 2, wherein the determining step comprises:
selecting a component from the obtained components, wherein the selected component is not one of the components that do not need to be checked;
obtaining a layer where the selected component is located, and obtains a power layer and a ground layer which are adjacent to the layer where the selected component is located, and checking whether copper foils between pins of the selected component in the adjacent ground layer and power layers are hollowed, when the selected component is a surface mounted device (SMD) component; and
making a decision that the selected component meets a predetermined requirement when the copper foils between pins of the selected component in the adjacent ground layer and power layer are hollowed; or
making a decision that the selected component does not meet the predetermined requirement when the copper foils between pins of the selected component in the adjacent ground layer and power layer are not hollowed.

6. The method according to claim 2, wherein the determining step comprises:
selecting a component from the obtained components, wherein the selected component is not one of the components that do not need to be checked;
obtaining all the ground layers and power layers from the PCB file; and
checking whether copper foils between pins of the selected component in all the ground layers and the power layers are hollowed when the selected component is not a surface mounted device (SMD) component; and
making a decision that the selected component meets a predetermined requirement when the copper foils between pins of the selected component in all the ground layers and the power layers are hollowed; or
making a decision that the selected component does not meet the predetermined requirement when the copper foils between pins of the selected component in all the ground layers and the power layers are not hollowed.

7. A computing device, comprising:
a non-transitory storage medium;
at least one processor; and
one or more modules that are stored in the non-transitory storage medium, and are executed by the at least one processor, the one or more modules comprising instructions to:
import a a printed circuit board (PCB) file;
designate a pair of differential signal lines;
locate the designated pair of differential signal lines in the PCB file;
obtain components connected by the differential signal lines and vias which the differential signal lines pass through, from the PCB file;
determine whether obtained components and the obtained vias meet predetermined requirements by checking whether copper foils between each pair of the obtained vias or between pins of the obtained components in ground layers and power layers of the PCB file are hollowed; and
output a check report which displays the pairs of vias and the components that do not meet the predetermined requirements.

8. The computing device according to claim 7, wherein the one or more modules further to:
designate one or more components that do not need to be checked; and
filter the designated components from the obtained components when determining whether obtained components meet the predetermined requirement.

9. The computing device according to claim 8, wherein the one or more modules further to:
provide a signal line list for a user to select a name of a pair of differential signal lines, and provide a component list for the user to select names of one or more components that do not need to be checked.

10. The computing device according to claim 7, wherein the determining step comprises:
selecting a pair of vias from the obtained vias;
obtaining all the ground layers and the power layers from the PCB file;
checking whether copper foils between the selected pair of the vias in all the ground layers and the power layers are hollowed; and
making a decision that the selected pair of vias meets a predetermined requirement when the copper foils between the selected pair of the vias in all the ground layers and power layers are hollowed; or
making a decision that the selected pair of vias does not meet the predetermined requirement when the copper foils between the selected pair of the vias in all the ground layers and the power layers are not hollowed.

11. The computing device according to claim 8, wherein the determining step comprises:
selecting a component from the obtained components, wherein the selected component is not one of the components that do not need to be checked;
obtaining a layer where the selected component is on, and obtains a power layer and a ground layer which are adjacent to the layer where the selected component is located, and checking whether copper foils between pins of the selected component in the adjacent ground layer and power layers are hollowed, when the selected component is a surface mounted device (SMD) component; and
making a decision that the selected component meets a predetermined requirement when the copper foils between pins of the selected component in the adjacent ground layer and power layer are hollowed; or
making a decision that the selected component does not meet the predetermined requirement when the copper foils between pins of the selected component in the adjacent ground layer and power layer are not hollowed.

12. The computing device according to claim 8, wherein the determining step comprises:
selecting a component from the obtained components, wherein the selected component is not one of the components that do not need to be checked;
obtaining all the ground layers and power layers from the PCB file; and
checking whether copper foils between pins of the selected component in all the ground layers and the power layers are hollowed when the selected component is not a surface mounted device (SMD) component; and
making a decision that the selected component meets a predetermined requirement when the copper foils between pins of the selected component in all the ground layers and the power layers are hollowed; or
making a decision that the selected component does not meet the predetermined requirement when the copper foils between pins of the selected component in all the ground layers and the power layers are not hollowed.

13. A non-transitory storage medium having stored thereon instructions that, when executed by a processor of a computing device, causes the processor to perform a method for checking wiring diagrams of a printed circuit board (PCB), the method comprising:
importing a PCB file;
designating a pair of differential signal lines;
locating the designated pair of differential signal lines in the PCB file;
obtaining components connected by the differential signal lines and vias which the differential signal lines pass through, from the PCB file;
determining whether obtained components and the obtained vias meet predetermined requirements by checking whether copper foils between each pair of the obtained vias or between pins of the obtained components in ground layers and power layers of the PCB file are hollowed; and
outputting a check report which displays the pairs of vias and the components that do not meet the predetermined requirements.

14. The non-transitory storage medium according to claim 13, wherein the method further comprises:
designating one or more components that do not need to be checked; and
filtering the designated components from the obtained components when determining whether obtained components meet the predetermined requirement.

15. The non-transitory storage medium according to claim 14, wherein the method further comprises:
providing a signal line list for a user to select a name of a pair of differential signal lines, and providing a component list for the user to select names of one or more components that do not need to be checked.

16. The non-transitory storage medium according to claim 13, wherein the determining step comprises:
selecting a pair of vias from the obtained vias;
obtaining all the ground layers and the power layers from the PCB file;
checking whether copper foils between the selected pair of the vias in all the ground layers and the power layers are hollowed; and
making a decision that the selected pair of vias meets a predetermined requirement when the copper foils between the selected pair of the vias in all the ground layers and power layers are hollowed; or
making a decision that the selected pair of vias does not meet the predetermined requirement when the copper foils between the selected pair of the vias in all the ground layers and the power layers are not hollowed.

17. The non-transitory storage medium according to claim 14, wherein the determining step comprises:
selecting a component from the obtained components, wherein the selected component is not one of the components that do not need to be checked;
obtaining a layer where the selected component is on, and obtains a power layer and a ground layer which are adjacent to the layer where the selected component is on, and checking whether copper foils between pins of the selected component in the adjacent ground layer and power layers are hollowed, when the selected component is a surface mounted device (SMD) component; and
making a decision that the selected component meets a predetermined requirement when the copper foils between pins of the selected component in the adjacent ground layer and power layer are hollowed; or
making a decision that the selected component does not meet the predetermined requirement when the copper foils between pins of the selected component in the adjacent ground layer and power layer are not hollowed.

18. The non-transitory storage medium according to claim 14, wherein the determining step comprises:
selecting a component from the obtained components, wherein the selected component is not one of the components that do not need to be checked;
obtaining all the ground layers and power layers from the PCB file; and
checking whether copper foils between pins of the selected component in all the ground layers and the power layers are hollowed when the selected component is not a surface mounted device (SMD) component; and
making a decision that the selected component meets a predetermined requirement when the copper foils between pins of the selected component in all the ground layers and the power layers are hollowed; or
making a decision that the selected component does not meet the predetermined requirement when the copper foils between pins of the selected component in all the ground layers and the power layers are not hollowed.
